(19) United States
(12) Patent Application Publication
(10) Pub. No.: US 2026/0037261 A1
(43) Pub. Date: Feb. 5, 2026

(54) INFORMATION PROCESSING DEVICE, METHOD, AND PROGRAM

(71) Applicant: Renesas Electronics Corporation, Tokyo (JP)

(72) Inventor: Daisuke KUMAGAI, Tokyo (JP)

(21) Appl. No.: 19/258,427

(22) Filed: Jul. 2, 2025

(30) Foreign Application Priority Data
Aug. 5, 2024 (JP) 2024-128818

(51) Int. Cl. G06F 9/30; G06F 9/451; G06F 9/455

(52) U.S. Cl. CPC G06F 9/30021; G06F 9/452; G06F 9/45512

(57) ABSTRACT

An information processing device is provided to quantitatively visualize the progress of execution of a program containing multiple instructions. The processor of the information processing device, when executing the control program instructions, causes the information processing device to perform operations. This operation includes collecting output data outputted with the execution of multiple instructions contained in a program when the program containing multiple instructions is executed, determining the progress of execution of the program containing multiple instructions based on the amount of the collected output data since the execution of the program containing multiple instructions began, and providing a user interface including an object representing the determined progress for display.

### CROSS-REFERENCE TO RELATED APPLICATIONS

The disclosure of Japanese Patent Application No. 2024-128818 filed on Aug. 5, 2024, including the specification, drawings and abstract is incorporated herein by reference in its entirety.

### BACKGROUND

This disclosure relates to a technology for obtaining the progress of executing a program that includes multiple instructions.

There is a disclosed techniques listed below.
[Patent Document 1] International Publication No. 2009/153967

A technology has been proposed for visually presenting the progress of execution when performing processing. For example, Patent Document 1 discloses a technique for displaying the erasure time required for the remaining capacity of a storage medium to reach a threshold or more when content stored in the storage medium is erased, using a progress bar.

### SUMMARY

There has been a demand from users to quantitatively visualize the progress of program execution when executing programs such as shell scripts that include multiple shell commands. However, the above-mentioned Patent Document 1 does not provide information that quantitatively indicates the progress of executing a shell script that includes multiple shell commands.

This disclosure has been made to solve the above issues and aims to provide an information processing apparatus, method, and program that can quantitatively display the progress of executing a program that includes multiple instructions.

Other issues and novel features will become apparent from the description of this specification and the accompanying drawings.

The processor of the information processing apparatus in this disclosure, when executing instructions of a control program, causes the information processing apparatus to perform operations. These operations include collecting output data that is outputted as multiple instructions contained in a program is executed when the program containing the multiple instructions is executed, determining the progress of execution of the program including the multiple instructions based on the amount of output data collected since the execution of the program including the multiple instructions began, and providing a user interface that includes an object representing the determined progress for display.

According to this disclosure, the progress of executing a program that includes multiple instructions can be quantitatively displayed.

### BRIEF DESCRIPTION OF THE DRAWINGS

FIG. 1 is a diagram illustrating a system 1000 according to an embodiment.

FIG. 2 is a diagram showing an example of the hardware configuration of the information processing apparatus 2 in FIG. 1.

FIG. 3 is a diagram explaining an example of information stored in Storage 215 of FIG. 2.

FIG. 4 is a diagram explaining an example of a function for calculating progress according to an embodiment.

FIG. 5 is a diagram explaining a display based on the UI according to an embodiment.

FIG. 6 is a diagram explaining a display based on the UI according to an embodiment.

FIG. 7 is a diagram explaining a display based on the UI according to an embodiment.

FIG. 8 is a diagram explaining a display based on the UI according to an embodiment.

FIG. 9 is a diagram explaining a display based on the UI according to an embodiment.

FIG. 10 is a flowchart showing a method according to an embodiment.

### DETAILED DESCRIPTION

The embodiments will be described in detail with reference to the drawings. In the drawings, the same or corresponding components are denoted by the same reference numerals, and description thereof will not be repeated. In this disclosure, a shell script containing multiple instructions is used as an example of a program containing multiple instructions, and a log representing the execution history of multiple instructions is used as an example of output data output as multiple instructions are executed. However, these are exemplary configurations, and the program containing multiple instructions and the output data output as multiple instructions are executed are not limited to these in this disclosure.

### SUMMARY

In the embodiment, the information processing apparatus collects logs representing the execution history of multiple instructions when executing a shell script containing multiple instructions. The multiple instructions include shell commands. The information processing apparatus collects logs representing the execution history of multiple instructions when the shell script is executed. Based on the amount of logs collected since the shell script started execution, the information processing apparatus determines the progress of executing the shell script and provides a UI (User Interface) that includes an object representing the determined progress for display. Therefore, the information processing apparatus can determine the progress of executing the shell script as a quantitatively indicated progress based on the amount of logs collected since the shell script started execution. Additionally, by providing a user interface that includes an object representing the progress for display, the user can visually grasp the acquired progress. In the embodiment, a “shell script” is defined as a script that includes multiple commands executable from an operating system shell, command line interpreter, etc.

In the embodiment, the multiple instructions of the shell script include instructions that define predetermined processing. The predetermined processing includes, for example, installation processing. The installation processing includes transferring software, which includes data or programs stored in a first storage medium, from the first storage medium to a second storage medium and setting the software in a state where it can be used (executed) on the second storage medium. This predetermined processing is not limited to installation processing.

### Configuration

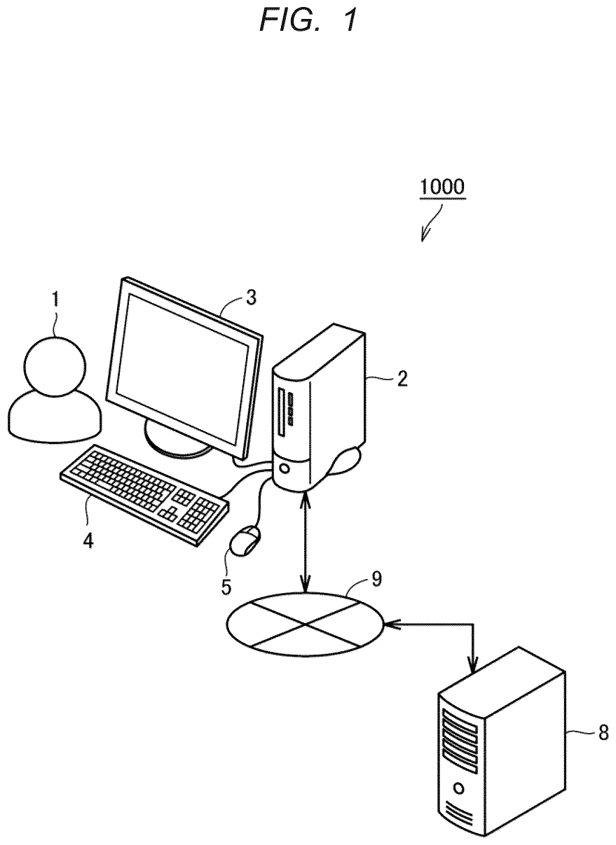

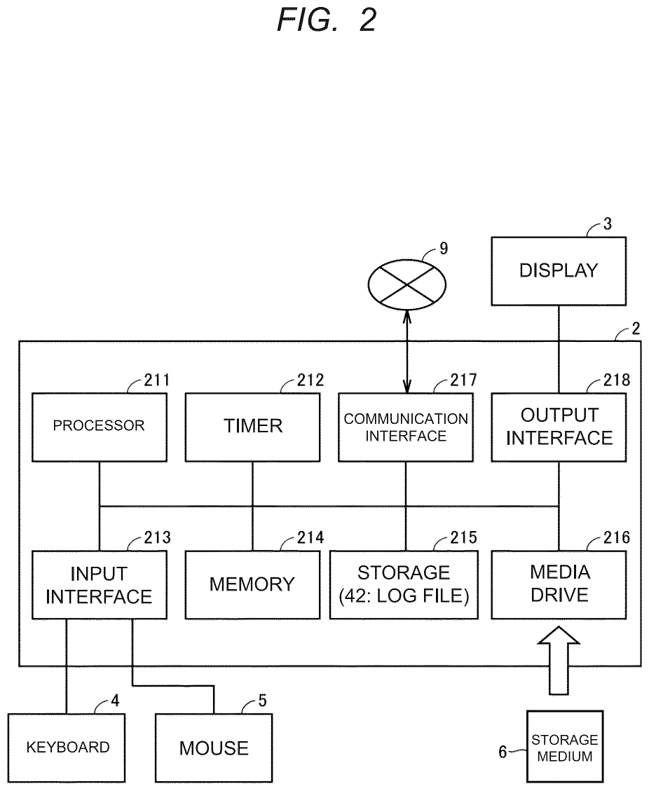

FIG. 1 is a diagram illustrating a system 1000 according to an embodiment. FIG. 2 is a diagram showing an example of the hardware configuration of the information processing apparatus 2 in FIG. 1.

The system 1000 in FIG. 1 includes an information processing apparatus 2, which is an example of a computer, and a server 8. The information processing apparatus 2 communicates with server 8 via network 9. The server 8 includes an on-premises server or a cloud server. Network 9 includes, for example, wired or wireless networks such as LAN (Local Area Network), WAN (Wide Area Network), and the Internet. The information processing apparatus 2 provides an environment where the user 1 can interactively operate the information processing apparatus 2, for example, using a UI (User Interface). The UI is a concept that includes a GUI (Graphical User Interface).

The information processing apparatus 2 in FIG. 2 includes a processor 211. Processor 211 realizes given functions by executing a program.

The information processing apparatus 2 further includes a timer 212, an input interface 213, a memory 214, a storage 215, a media drive 216, a communication interface 217 for communicating with the network 9, and an output interface 218. Each component in the information processing apparatus 2 is connected to each other via a bus.

The input interface 213 connects input devices, including a keyboard 4 and a mouse 5, which the user 1 can operate. The processor 211 accepts input from the keyboard 4 and mouse 5 via the input interface 213. The media drive 216 allows a storage medium 6 to be detachably mounted. Processor 211 reads data from and writes data to the storage medium 6 via the media drive 216.

The information processing apparatus 2 may include a multiprocessor having two or more processors 211. The processor includes a CPU (Central Processing Unit) or MPU (Micro 211 Processing Unit). The processor 211 may be realized as a multi-core processor.

The memory 214 includes ROM (Read Only Memory) or RAM (Random Access Memory). The information stored in memory 214 includes log file 42, which will be described later. The storage 215 is a medium for non-temporarily storing information, including, for example, HDD (Hard Disk Drive), SSD (Solid State Drive), USB (Universal Serial Bus) memory, and SD (Secure Digital, registered trademark) memory cards.

The storage medium 6 is a medium that non-temporarily stores information such as programs recorded by the media drive 216, so that the information can be read, using electrical, magnetic, optical, mechanical, or chemical action. At least one of the memories 214, storage 215, and storage medium 6 constitutes a storage unit for the processing apparatus 2 to store programs and data.

The output interface 218 connects a display 3 via wired or wireless means. Processor 211 outputs display control data to display 3 via the output interface 218. The display 3 displays images on the screen according to the display control data. In the information processing apparatus 2, display 3, keyboard 4, and mouse 5 may be realized by a touch panel. When such a touch panel is realized, the input interface 213 and output interface 218 are provided as circuits for communicating with the touch panel.

In FIG. 1, the information processing apparatus 2 is shown as a desktop computer, but it is not limited to a desktop type and may be a portable tablet, laptop, or notebook computer. Additionally, the information processing apparatus 2 may be realized as a computer mounted on a smartphone.

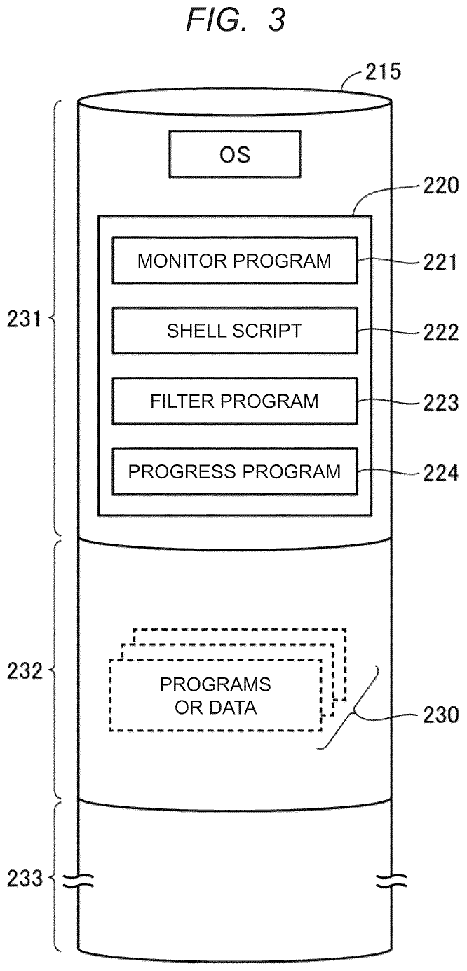

FIG. 3 is a diagram explaining an example of information stored in Storage 215 of FIG. 2. Storage 215 includes areas 231, 232, and 233. Area 231 includes an area for storing programs and data executed by processor 211. The programs in area 231 include system programs, including an OS (Operating System), and application programs 220. Area 232 includes an area for storing installed programs or data 230. Region 233 is an area for storing other programs or data.

When the processor 211 executes the necessary program stored in the storage 215, it reads the necessary program from the storage 215 and deploys it to the RAM of memory 214. Then, processor 211 executes the program deployed in the RAM to control each part of the information processing device 2.

The application program 220 includes a monitor program 221, a shell script 222, a filter program 223, and a progress program 224. The application program 220, excluding the shell script 222, includes program code containing source code, intermediate code, or object code.

The shell script 222 includes multiple instructions that define the installation process. When these instructions are executed by processor 211, the information processing device 2 performs the installation process and outputs a log indicating the execution history of the instructions.

The shell script 222 is in the form of a text file describing multiple shell commands corresponding to the instructions. The processor 211 interprets and executes each shell command, which is an instruction included in the shell script 222, using an interpreter provided by the information processing device 2, and outputs a log. The execution history indicated by the log includes the execution result showing whether the instruction execution was successful or failed, or the executed instruction such as a shell command or command line but is not limited to these.

Monitor program 221 triggered it to start when the shell script 222 begins execution. When the monitor program 221 is executed, the information processing device 2 performs monitoring processing to oversee the execution of the shell script 222. This allows the information processing device 2 to perform the monitoring process of monitor program 221 in parallel with the installation process of the shell script 222. Monitor program 221 constitutes a program that controls the information processing device 2 to perform the monitoring process.

In the monitoring process, the information processing device 2 writes the log to the log file 42 each time a log is output during the execution of the shell script 222, thereby collecting and storing a series of logs output from the start to the end of the execution of the shell script 222 in the log file 42.

In the embodiment, log file 42 is stored in memory 214, but the storage medium for log file 42 is not limited to memory 214 and may be storage 215 or storage medium 6.

Monitor program 221 is configured to specify and execute the filter program 223 and the progress program 224, i.e., to call the filter program 223 and the progress program 224. When the filter program 223 is executed, the information processing device 2 performs filtering. In the filtering process, the information processing device 2 detects the amount of logs stored in the log file 42 and determines the progress degree indicating the progress of the execution of the shell script 222 based on the detected amount of logs.

When progress program 224 is executed, the information processing device 2 performs progress processing. In the progress processing, a UI including an object representing the progress degree determined in the filtering process is provided for display. Providing this “UI including an object representing the progress degree” involves the information processing device 2 generating display control data that includes the progress degree and the specification of the object representing the progress degree and outputting it to the output interface 218. The display control circuit (not shown) of display 3 controls the screen display according to the display control data output from the output interface 218. As a result, an image of the UI including the object representing the progress degree is displayed on the screen of the display 3.

In the embodiment, the filter program 223 and the progress program 224 are implemented as programs independent of the monitor program 221 in the information processing device 2, but the method of implementing the programs is not limited to this. For example, monitor program 221 may be designed to include the program code of the filter program 223 and the progress program 224.

### Determination of Progress Degree

The inventor focused on the fact that logs are output when multiple instructions of a shell script are executed and found that the progress degree of the execution of the shell script can be pseudo-indicated by the amount of logs collected from the start of the execution of the shell script.

Based on such findings, the inventor found that if a function f(x) satisfies the following conditions, the progress degree can be calculated using the function f(x).

### Condition 1

Set the parameter K as the upper limit value of the function f(x) with the amount of collected logs (x) as input. That is, even if the amount of collected logs (x) increases, the value of the function f(x) indicates the progress degree does not exceed the parameter K.

### Condition 2

The progress degree always increases until the execution of the shell script is completed. That is, the function f(x) is a monotonically increasing function with respect to x under the condition (0<x<=infinity).

### Condition 3

The function f(x) shows f(x)=0 when x=0.

The inventor identified the Gompertz function, which is one of the growth curves, as a function satisfying (Condition 1), (Condition 2), and (Condition 3). In the function f(x) representing the growth curve, the increment of the f(x) value with respect to the increment of x is small in the initial stage where the amount of collected logs (x) is small, large in the intermediate stage where the amount of collected logs (x) is increasing, and small in the final stage where the amount of collected logs (x) is large. As a function satisfying (Condition 1), (Condition 2), and (Condition 3), a function configured such that the progress degree f(x) asymptotically approaches the limit value indicated by the parameter K as the amount of collected logs (x) increases may be adopted. Therefore, the function f(x) is not limited to the Gompertz function and may be another growth curve such as a sigmoid function or a logistic function.

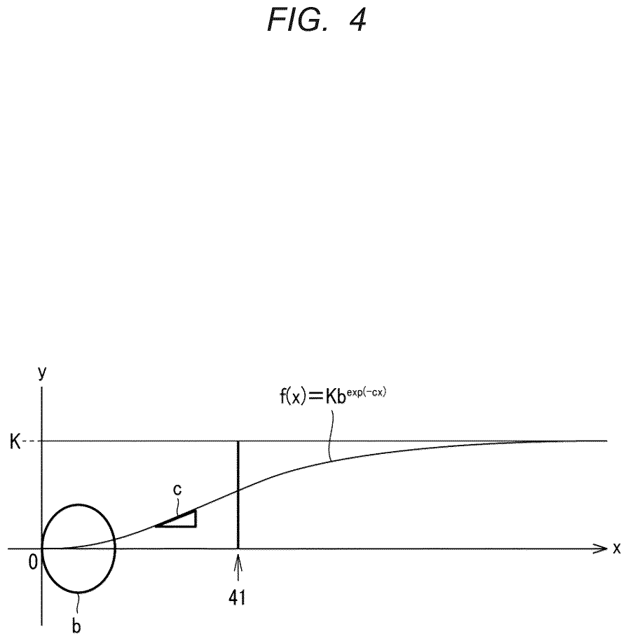

FIG. 4 is a diagram illustrating an example of a function for calculating the progress degree according to the embodiment. In FIG. 4, a graph of the function f(x)=Kb^{exp(-cx)} satisfying the above (Condition 1) to (Condition 3) is shown. In FIG. 4, the amount of logs held in log file 42 is assigned to the horizontal axis “x”, and the progress degree is assigned to the vertical axis “y” in the two-dimensional coordinates, and the function f(x) is shown as a graph of a monotonically increasing curve. In the embodiment, the log representing the execution history includes, for example, characters, and the amount of logs indicates the total number of characters or words collected in log file 42.

### Adjustment of Parameters

The function f(x) has a parameter b indicating the rise of the monotonically increasing curve, a parameter c indicating the slope of the monotonically increasing curve, and a parameter K indicating the upper limit of the monotonically increasing curve. In the embodiment, parameter b and parameter K are set to fixed values, and the parameter c is set as a variable value. By setting the parameters in this way, when the adjustment command of the filter program 223 is executed, the overall shape of the monotonically increasing curve of the function f(x) is almost fixed, while the slope of the monotonically increasing curve corresponding to the value of the parameter c is changed.

The timing and method of adjusting the slope parameter c will be described. The timing of adjustment includes before and during the execution of the shell script 222.

Before the execution of the shell script 222, the parameter c is adjusted based on static information related to the shell script 222. For example, the information processing device 2 detects the number of instructions of shell commands included in the shell script 222 and determines the value of the parameter c so that the detected number of instructions and the slope value are in an approximately inverse proportional relationship.

More specifically, the information processing device 2 scans the shell script of the shell script 222 to extract instructions (shell commands), counts the total number of extracted instructions, and obtains the value of the parameter c corresponding to the total number of instructions. Information processing device 2 obtains the value of the parameter c corresponding to the total number of instructions by calculating using a predetermined formula or by searching from a lookup table.

For example, the more the total number of instructions, the slower the change speed of the progress degree, so a small value is set for the parameter c, and the fewer the total number of instructions, the faster the change speed of the progress degree, so a large value is set for the parameter c. Note that the static information is not limited to the number of instructions and may be the number of shell command lines constituting the shell script.

As a method of adjusting the value of parameter c during the execution of the shell script 222, the parameter c is adjusted based on dynamic information. The dynamic information includes the amount of logs collected in the log file 42 during the execution of the shell script 222.

In the embodiment, the filter program 223 has an adjustment command for adjusting the parameters of the function f(x). When the adjustment command is executed, the information processing device 2 adjusts the parameter c using dynamic information.

For example, the information processing device 2 adjusts the parameter c based on the rate of increase in the amount of logs. For instance, if the amount of logs collected in the log file 42 (the total number of characters indicated by the logs) exceeds the amount of checkpoint 41 in FIG. 4 earlier than a predetermined time, the value of parameter c is reduced so that the slope becomes smaller. This predetermined time indicates the elapsed time from the start of execution of the shell script 222. The amount of checkpoint 41, for example, indicates that there are 200 characters or words.

More specifically, the information processing device 2 calculates the above predetermined time according to a predetermined calculation formula based on the total number of instructions contained in the shell script 222, or searches for the above predetermined time from a lookup table based on the total number of processing instructions. The information processing device 2 determines whether the condition “the amount of logs acquired in the predetermined time exceeds the amount of checkpoint 41” is satisfied, and when it determines that the condition is satisfied, it reduces the value of parameter c so that the slope becomes smaller.

Additionally, the information processing device 2 measures the rate of increase in the amount of logs in the log file 42 and adjusts the value of parameter c to be proportional to the measured rate of increase.

Furthermore, when a specific log is collected, such as when a log indicating a keyword is collected, the information processing device 2 adjusts the value of parameter c. More specifically, the information processing device 2 scans the logs in the log file 42 in parallel with the execution of the shell script 222 and extracts words. The information processing device 2 matches the extracted words with keywords, and if it determines that a word matching a keyword has been extracted (collected), it increases the value of parameter c so that the slope becomes larger.

Keywords include, for example, words indicated by logs output when the shell script 222 is started (e.g., “start”), words indicated by logs output between the start and end of execution (e.g., “success”), or words indicated by logs output at the end of execution (e.g., “finish”).

In this way, the information processing device 2 adjusts the value of parameter c based on information derived from the collected logs, namely, information based on the rate of increase in the amount of logs collected when the shell script 222 is executed, or information that a specific log, which is keyword, has been collected.

Information processing device 2 is configured to implement one of the methods for dynamically adjusting the value of parameter c mentioned above, or to implement a combination of two or more methods. Additionally, the information processing device 2 is configured to implement a combination of static and dynamic adjustment methods.

When the information processing device 2 detects that the execution of the shell script 222 has ended, it changes (sets) the value of the function f(x) to the upper limit value of parameter K. Information processing device 2 detects the end of execution based on a keyword indicating the end of execution of the shell script 222 (e.g., “finish”) or a status representing the execution state of the shell script 222.

### UI Display Example

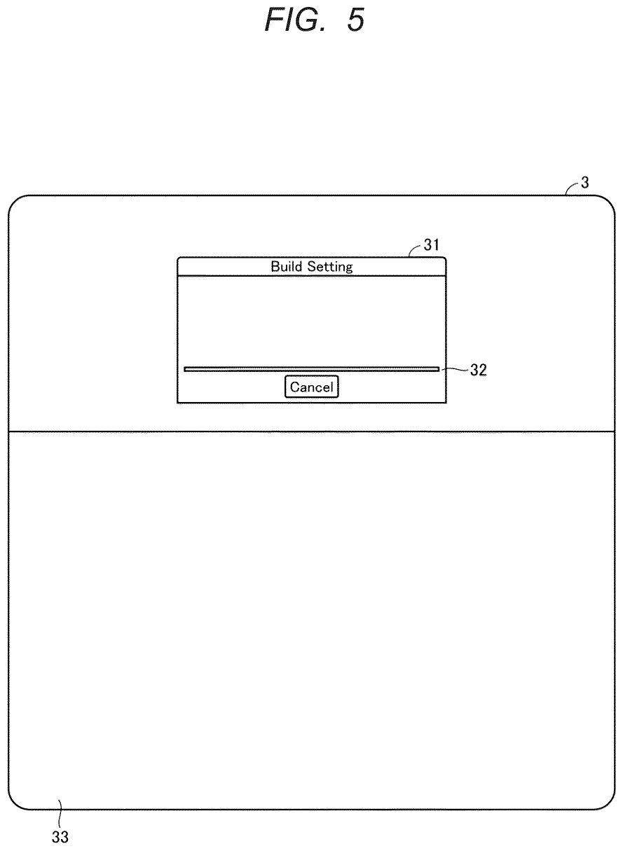

FIGS. 5 to 9 are diagrams illustrating displays based on the UI according to the embodiment. In FIGS. 5 to 9, the UI screen displayed on display 3 based on the display control data is shown. The screen in FIG. 5 displays an image at the time when the user instruction to start executing the shell script 222 is received. The image includes objects of windows 31 and 33. Window 31 includes an object of bar 32. Bar 32 has a length corresponding to the maximum value of progress, i.e., the upper limit value of parameter K. In window 33, an object representing the logs collected in log file 42 is displayed.

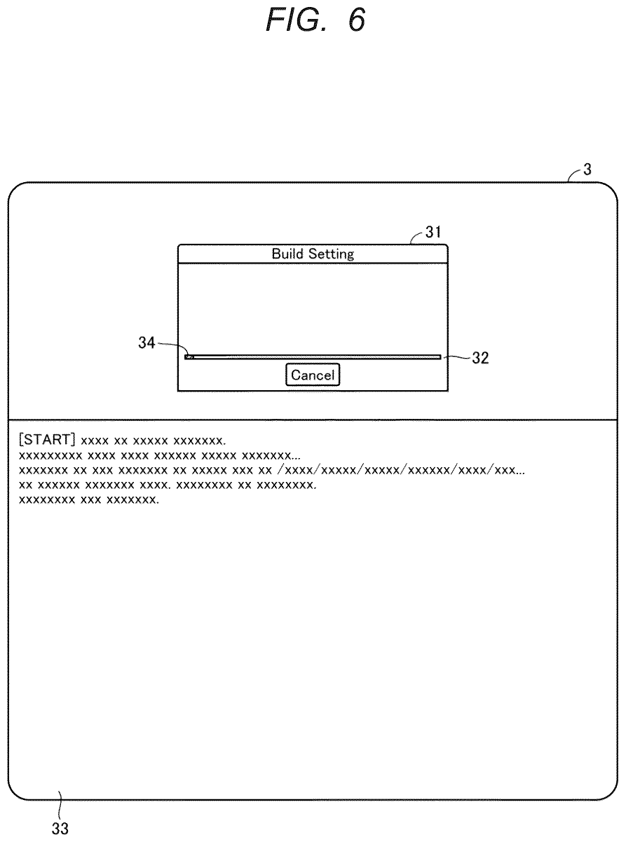

The screen in FIG. 6 displays an image immediately after the start of execution of the shell script 222. Window 31 has a progress bar 34, which is an example of an object representing progress, arranged overlapping bar 32. Progress bar 34 extends in the longitudinal direction on bar 32, for example, from the left end starting point to the right end, in conjunction with the change in progress (the value of the function f(x)) determined during the execution of the shell script 222.

Therefore, progress is quantitatively displayed by the length of progress bar 34. Additionally, a value indicating progress may be displayed in association with progress bar 34.

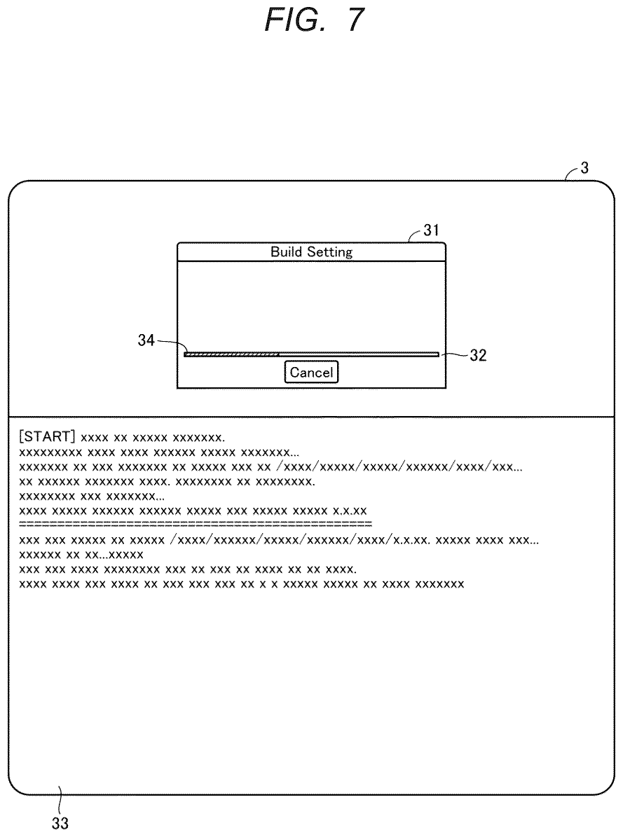

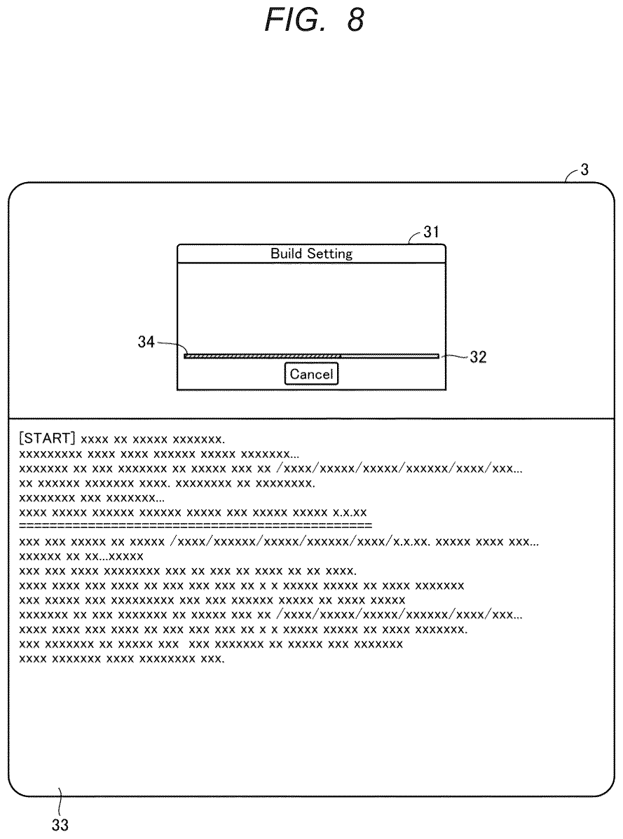

The screen in FIG. 7 displays an image when more time has elapsed. In FIG. 7, the amount of logs displayed in window 33 has increased compared to the amount of logs in FIG. 6, and progress bar 34 has also extended further. In the screen of FIG. 8, when more time has elapsed, the amount of logs displayed in window 33 has further increased, and progress bar 34 has also extended further.

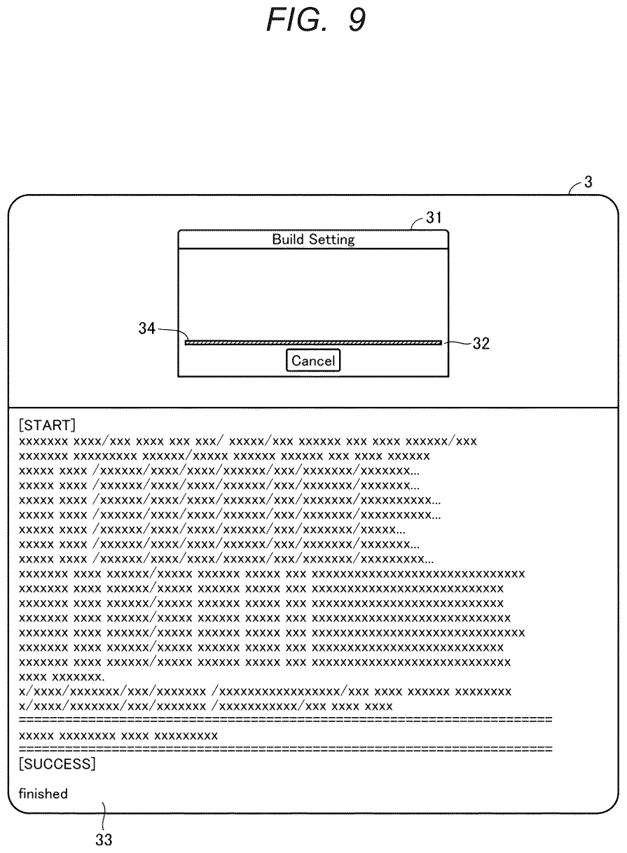

The screen in FIG. 9 displays an image when the execution of the shell script 222 has ended. In FIG. 9, the logs collected from the start to the end of execution of the shell script 222 are displayed in window 33. Also, the tip of the progress bar 34 extends to the right end of bar 32, indicating that the execution of the shell script 222 has been completed, i.e., the installation process has ended. In the screen of FIG. 9, an object such as a message notifying the completion of the installation process may also be displayed.

User 1 can grasp the progress of the installation process in real-time based on the change in the length of the progress bar 34 displayed on the screen in FIG. 7 or FIG. 8. Additionally, user 1 can visually grasp an estimate of the time required until the end of the installation process or the remaining amount of data to be installed based on the position of the tip of the progress bar on bar 32.

### Flowchart

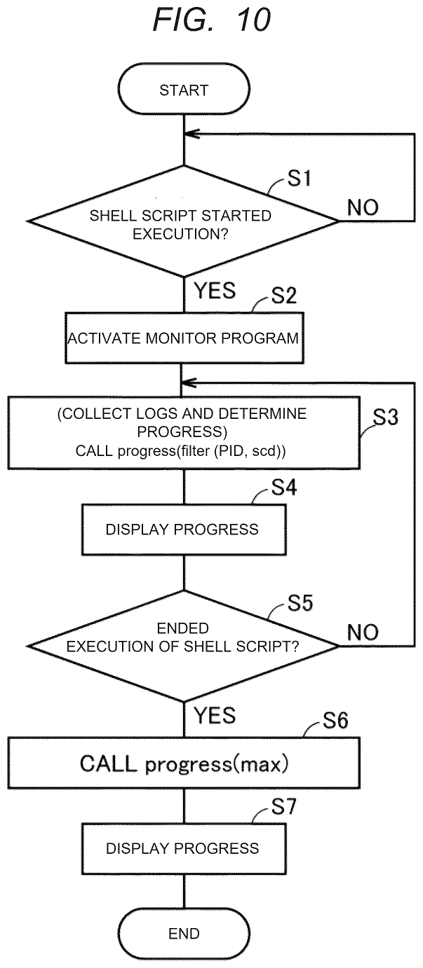

FIG. 10 is a flowchart illustrating the method according to the embodiment. This flowchart includes steps constituting the monitoring process. The information processing device 2 determines whether it receives an instruction from user 1 to start the installation via the keyboard 4 or mouse 5 (step S1). If it determines that it does not receive the instruction (NO in step S1), it repeats step S1, but if it determines that it has received the instruction (YES in step S1), it starts executing the shell script 222.

When the execution of the shell script 222 is started, the information processing device 2 activates the monitor program 221 (step S2). When monitor program 221 is activated, the information processing device 2 generates a new log file 42. Thereafter, the shell script 222 and the monitor program 221 are executed in parallel in the information processing device 2.

In the monitoring process, the information processing device 2 collects logs into the log file 24. Additionally, in the monitoring process, the information processing device 2 performs filtering to determine the progress and performs progress processing to provide a UI including an object representing the progress (step S3).

More specifically, processor 211 executes the command “CALL progress (filter (PID, scd))” included in monitor program 221. In this command, (PID, scd) indicates the logs stored in log file 42. “filter (PID, scd)” indicates a command instructing the execution of the filter program 223 with (PID, scd) as arguments (inputs), and “progress (filter (PID, scd)” indicates a command instructing the execution of the progress program 224 with the execution result of the filter program 223 as arguments (inputs). Therefore, in step S3, “CALL progress (filter (PID, scd))” is executed, and as a result of its execution, the amount of logs stored in log file 42 at the time of executing the command is obtained, the progress based on the obtained amount of logs is determined, and a UI including an object representing the progress is provided.

Display 3 displays an image indicating the progress (step S4). More specifically, the display control circuit of display 3 receives the display control data included in the UI provided in step S3 and controls the screen to display the image according to the display control data received. On the screen, an image including an object representing the corresponding progress during the execution of the installation process is displayed.

Information processing device 2 determines whether the execution has ended based on the status representing the execution state of the shell script 222 (step S5). If it is determined that the execution of the shell script 222 has not ended (NO in step S5), the information processing device 2 returns to step S3 and executes the processing of step S3. In this way, as long as it is determined that the shell script 222 has not ended, the processing of steps S3 and S4 is repeatedly performed.

When the information processing device 2 determines that the execution of the shell script 222 has ended (YES in step S5), it proceeds to step S6. The information processing device 2 determines the “progress” indicating that the execution of the shell script 222 has been completed and provides a UI including an object representing the progress (step S6).

More specifically, in step S6, processor 211 executes the instruction “CALL progress (max)” included in the monitor program 221. The argument “max” in “progress (max)” of this instruction indicates a predetermined value that signifies the completion of the execution of the shell script 222. Therefore, as a result of executing “CALL progress (max)” in step S6, a UI including a progress bar 34 indicating a length corresponding to the value of parameter K is provided.

Display 3 shows an image indicating the progress (step S7). More specifically, the display control circuit of display 3 receives the display control data included in the UI provided in step S6 and controls the screen to display an image according to the received display control data. The screen displays the image of FIG. 9, which includes an object representing the progress indicating the completion of the installation process.

### Program

In the embodiment, a program is provided to execute the above-mentioned process on processor 211. Such a program can be non-temporarily recorded on the storage medium 6 of the information processing devices 2, which is a computer, and provided as a program product. Alternatively, it can be non-temporarily recorded on a storage medium such as storage 215 built into the computer, and the program can be provided. Additionally, the program can be provided via download over network 9. The storage medium 6 includes computer-readable storage media such as a flexible disk, CD-ROM (Compact Disk-Read Only Memory), ROM, RAM, and memory cards attached to the computer.

The provided computer program product is installed and executed in a program storage section such as a hard disk. The program product includes the program itself and the storage medium on which the program is recorded.

### Additional Statement

In the embodiment, a computer program product having the following configuration is provided.

### Configuration 1

A computer program product stored on a computer-readable storage medium, including:
computer code for executing multiple instructions contained in a computer program containing the multiple instructions, and determining the progress of execution of the computer program containing the multiple instructions based on the amount of output data outputted with the execution of the multiple instructions collected since the execution of the multiple instructions began, and
computer code for providing a user interface including an object representing the progress for display.

### Configuration 2

The computer program product according to Configuration 1, wherein the object includes a progress bar having a length corresponding to the progress.

### Configuration 3

The computer program product according to Configuration 2, wherein the length of the progress bar corresponds to a monotonically increasing function of the amount of the output data.

### Configuration 4

The computer program product according to Configuration 3, wherein the monotonically increasing function includes at least one parameter; and
wherein the operation further includes adjusting at least one parameter based on the amount of the collected output data and the progress.

### Configuration 5

The computer program product according to Configuration 3, wherein the value of the monotonically increasing function asymptotically approaches a predetermined limit value as the amount of the collected output data increases.

### Configuration 6

The computer program product according to Configuration 5, wherein the monotonically increasing function is represented by f(x) when the amount of the output data is x, and f(x) satisfies the following conditions:
(Condition 1) when parameter K is given as an upper limit, the value of f(x) is less than or equal to parameter K regardless of the value of x;
(Condition 2) f(x) monotonically increases with the increase of x under the condition (0<x<=infinity); and
(Condition 3) the function f(0)=0.

Although the present disclosure has been specifically described based on the embodiments made by the inventor, it is needless to say that the present disclosure is not limited to the embodiments, and various modifications can be made without departing from the gist thereof.

What is claimed is:

1. An information processing device comprising:
a processor; and
a storage section for storing instructions to be executed by the processor to cause the information processing device to perform operations,
wherein the instructions include a program containing multiple instructions and control program instructions, and
wherein, the processor, when executing the control program instructions, causes the information processing device to:
collect output data outputted with the execution of the multiple instructions when the program containing the multiple instructions is executed;
determine the progress of execution of the program containing the multiple instructions based on the amount of the collected output data since the execution of the program containing the multiple instructions began; and
provide a user interface including an object representing the progress for display.

2. The information processing device according to claim 1, wherein the object includes a progress bar having a length corresponding to the progress.

3. The information processing device according to claim 2, wherein the length of the progress bar corresponds to a monotonically increasing function of the amount of the output data.

4. The information processing device according to claim 3, wherein the monotonically increasing function includes at least one parameter; and
wherein the operation further includes adjusting the at least one parameter based on the amount of the collected output data and the progress.

5. The information processing device according to claim 3, wherein the value of the monotonically increasing function asymptotically approaches a predetermined limit value as the amount of the collected output data increases.

6. The information processing device according to claim 5, wherein the monotonically increasing function is represented by f(x) when the amount of the output data is x, and f(x) satisfies the following conditions:
(Condition 1) when a parameter K is given as an upper limit, the value of f(x) is less than or equal to the parameter K regardless of the value of x;
(Condition 2) f(x) monotonically increases with the increase of x under the condition (0<x<=infinity); and
(Condition 3) the function f(0)=0.

7. A method implemented by a computer, comprising:
collecting output data outputted with the execution of multiple instructions when a program containing the multiple instructions is executed;
determining the progress of execution of the program containing the multiple instructions based on the amount of the collected output data since the execution of the program containing the multiple instructions began; and
providing a user interface including an object representing the progress for display.

8. The method according to claim 7, wherein the object includes a progress bar having a length corresponding to the progress.

9. The method according to claim 8, wherein the length of the progress bar corresponds to a monotonically increasing function of the amount of the output data.

10. The method according to claim 9,
wherein the monotonically increasing function includes at least one parameter; and
wherein the method further includes adjusting at least one parameter based on the amount of the collected output data and the progress.

11. The method according to claim 9, wherein the value of the monotonically increasing function asymptotically approaches a predetermined limit value as the amount of the collected output data increases.

12. The method according to claim 11, wherein the monotonically increasing function is represented by f(x) when the amount of the output data is x, and f(x) satisfies the following conditions:
(Condition 1) when a parameter K is given as an upper limit, the value of f(x) is less than or equal to the parameter K regardless of the value of x;
(Condition 2) f(x) monotonically increases with the increase of x under the condition (0<x<=infinity); and
(Condition 3) the function f (0)=0.

13. A program for causing a computer to:
collect output data outputted with the execution of multiple instructions when a program containing the multiple instructions is executed;
determine the progress of execution of the program containing the multiple instructions based on the amount of the collected output data since the execution of the program containing the multiple instructions began; and
provide a user interface including an object representing the progress for display.

14. The program according to claim 13, wherein the object includes a progress bar having a length corresponding to the progress.

15. The program according to claim 14, wherein the length of the progress bar corresponds to a monotonically increasing function of the amount of the output data.

16. The program according to claim 15,
wherein the monotonically increasing function includes at least one parameter; and
wherein the program further causes the computer to adjust the at least one parameter based on the amount of the collected output data and the progress.

17. The program according to claim 16, wherein the value of the monotonically increasing function asymptotically approaches a predetermined limit value as the amount of the collected output data increases.

18. The program according to claim 17, wherein the monotonically increasing function is represented by f(x) when the amount of the output data is x, and f(x) satisfies the following conditions:
(Condition 1) when a parameter K is given as an upper limit, the value of f(x) is less than or equal to parameter K regardless of the value of x;
(Condition 2) f(x) monotonically increases with the increase of x under the condition (0<x<=infinity); and
(Condition 3) the function f(0)=0.
